(19) United States
(12) Patent Application Publication
(10) Pub. No.: US 2019/0376540 A1
(43) Pub. Date: Dec. 12, 2019

(54) SYSTEM FOR FASTENING A FIRST COMPONENT TO A SECOND COMPONENT

(71) Applicant: ILLINOIS TOOL WORKS INC., Glenview, IL (US)

(72) Inventors: Nelson SANTOS, Iserlohn (DE); Bruno DA ROCHA, Altena (DE); Sven BECKER, Bochum (DE)

(21) Appl. No.: 16/422,272

(22) Filed: May 24, 2019

(30) Foreign Application Priority Data
Jun. 11, 2018 (DE) 10 2018 113 895.4

(51) Int. Cl. F16B 5/02; F16B 37/00

(52) U.S. Cl. CPC F16B 5/0233; F16B 37/00

(57) ABSTRACT

A system for fastening a first component with a through opening to a second component of a vehicle, including the first component and a fastening bolt, wherein a first delimiting sleeve with a first contact flange and a second delimiting sleeve with a second contact flange are provided, wherein the first delimiting sleeve and the second delimiting sleeve are insertable from opposite sides into the through opening of the first component and are connectable to each other by insertion of the first delimiting sleeve into the second delimiting sleeve such that the first contact flange and the second contact flange lie against the first component from opposite sides, wherein the fastening bolt is insertable through the delimiting sleeves into a fastening receptacle of the second component, and wherein the outer diameter of the second delimiting sleeve is smaller than the inner diameter of the through opening of the first component.

### TECHNICAL FIELD

The invention relates to a system for fastening a first component with a through opening to a second component, in particular a second component of a vehicle, such as a passenger car or truck, comprising the first component and a fastening bolt.

### BACKGROUND

A very wide variety of vehicle components can be connected to one another with systems of this type. For this purpose, the fastening bolt is plugged through the through opening of the first component and fastened, for example, screwed, in a fastening receptacle of the second component, for example an internal thread. Due to production tolerances and in particular in the case of a plurality of fastening points, it is not always possible here to exactly align the through opening of the first component with the corresponding fastening receptacle in the second component. There is therefore a need to provide compensation for tolerances in the radial direction.

Taking the explained prior art as the starting point, the invention is therefore based on the object of providing a system of the type mentioned at the beginning which, while being easy to install, provides radial compensation for tolerances as far as possible in each radial direction.

The invention achieves the object by the subject matter of claim 1. Advantageous refinements are found in the dependent claims, the description and the figures.

For a system of the type mentioned at the beginning, the invention achieves the object

in that a first delimiting sleeve with a first contact flange and a second delimiting sleeve with a second contact flange are provided, wherein the first delimiting sleeve and the second delimiting sleeve are insertable from opposite sides into the through opening of the first component and are connectable to each other by insertion of the first delimiting sleeve into the second delimiting sleeve such that the first contact flange and the second contact flange lie against the first component from opposite sides, wherein the fastening bolt is insertable through the delimiting sleeves into a fastening receptacle of the second component, and

in that the outer diameter of the second delimiting sleeve is smaller than the inner diameter of the through opening of the first component.

The components which can be connected to one another by the system according to the invention can be in particular components of a vehicle, such as a passenger vehicle or truck. Components of an oil sump are mentioned merely by way of example. According to the invention, a first delimiting sleeve with a first contact flange and a second delimiting sleeve with a second contact flange are provided. The first delimiting sleeve can have a circular cylindrical outer circumferential surface and a circular cylindrical inner circumferential surface. The second delimiting sleeve can likewise have a circular cylindrical outer circumferential surface and a circular cylindrical inner circumferential surface. The through opening of the first component can be circular-cylindrical. The first contact flange can be configured, for example, in the shape of a circular ring. The second contact flange can also be configured, for example, in the shape of a circular ring. The fastening bolt can have a bolt head which is enlarged in cross section in relation to a shank portion and, in the mounted state, lies against the upper side of the first contact flange of the first delimiting sleeve. The fastening bolt is inserted with the shank portion into a fastening receptacle of the second component and is fastened therein. As a result, the first component is securely held between the bolt head or the first contact flange of the first delimiting sleeve and the second component or the second contact flange of the second delimiting sleeve. The system according to the invention can also comprise the second component. The fastening bolt can be composed, for example, of metal. The fastening bolt can be a screw bolt which is then screwed into a corresponding thread of the second component.

The first delimiting sleeve and the second delimiting sleeve are inserted from opposite sides into the through opening of the first component and are connected to each other in the through opening. The first contact flange of the first delimiting sleeve then enters into contact with the first component from one side and the second contact flange of the second delimiting sleeve enters into contact with the first component from an opposite side. The contact flanges can lie against opposite sides of the first component in particular in such a manner that a (slight) clamping can be present, and therefore the delimiting sleeves do not automatically slip, but are laterally displaceable manually or by means of an installation force. However, such a clamping is not required. Said lateral displaceability is made possible according to the invention in that the outer diameter of the second delimiting sleeve is smaller than the inner diameter of the through opening of the first component. The outer circumferential surface of the second delimiting sleeve forms the outer side of the delimiting sleeves which are connected to each other. Since there is a distance between said outer circumferential surface of the second delimiting sleeve and the inner circumferential surface of the through opening, the delimiting sleeves and, with the latter, the fastening bolt which is guided through the delimiting sleeves can be displaced in the radial direction with respect to the longitudinal axis of the fastening bolt or the installation direction of the fastening bolt. As a result, when through opening and fastening receptacle are not aligned exactly with respect to each other, compensation for tolerances in the radial direction can take place. In particular, possible erroneous alignments between the through opening of the first component and the fastening receptacle of the second component can thereby be compensated for. The distance formed because of the smaller outer diameter of the second delimiting sleeve in comparison to the inner diameter of the through opening of the first component can exist here in particular over the entire circumference of the second delimiting sleeve. Compensation for tolerances in each radial direction is therefore possible. For example, the outer diameter of the second delimiting sleeve can be reduced by at least 10%, preferably at least 20%, in relation to the inner diameter of the through opening of the first component. A radial distance between the outer circumferential surface of the second delimiting sleeve and the inner circumferential surface of the through opening of the first component can be, for example, at least 2 mm, preferably at least 4 mm.

The system according to the invention firstly permits easy installation of the first component on the second component. Secondly, it permits comprehensive radial compensation for tolerances in a structurally simple manner.

According to one refinement, latching means can be provided for latching the first delimiting sleeve to the second delimiting sleeve when the first delimiting sleeve is inserted into the second delimiting sleeve. This results in particularly easy installation, with removability being able to be realized easily at the same time.

According to a further refinement, the latching means can comprise at least one latching projection and/or at least one latching receptacle on the outer circumferential surface of the first delimiting sleeve and at least one latching projection and/or at least one latching receptacle on the inner circumferential surface of the second delimiting sleeve. In principle, any desired combinations of latching elements are conceivable. For example, a plurality of latching projections could be provided on one of the delimiting sleeves and an annular latching projection could be provided on the other delimiting sleeve. By means of such an annular latching projection, latching of the delimiting sleeves to one another in any desired rotational positions is possible.

According to a further refinement, holding means can be provided for holding the fastening bolt in the first delimiting sleeve in a preassembly position. This further facilitates the installation and the delivery to the installation site by the fastening bolt being temporarily held in the first delimiting sleeve. It can therefore be connected captively to the first delimiting sleeve during transportation and, at the installation site, can be mounted easily together with the first delimiting sleeve on the second delimiting sleeve.

According to a particularly practical refinement, the holding means can comprise latching means on the inner circumferential surface of the first delimiting sleeve. The latching means can comprise at least one latching projection and/or at least one latching receptacle on the inner circumferential surface of the first delimiting sleeve. Particularly easy holding takes place by means of the latching means. For example, the latching means of the first delimiting sleeve can latch on a thread of the fastening bolt.

However, it is also conceivable for the holding means to comprise latching means on the outer circumferential surface of the fastening bolt. The latching means in turn can then comprise at least one latching projection and/or at least one latching receptacle on the outer circumferential surface of the fastening bolt. For example, an annular latching projection could be formed on the fastening bolt above the thread on the side facing the bolt head.

According to a further refinement, the holding means can comprise a holding sleeve which can be pushed onto the fastening bolt and can be inserted into the first delimiting sleeve. An additional holding element is therefore then provided. The holding sleeve can be, for example, of substantially circular cylindrical design. The provision of an additional holding sleeve can be advantageous since no further measures for holding means have to be taken, for example, on the fastening bolt and optionally also on the first delimiting sleeve. In addition, by means of the provision of an additional holding sleeve, the axial relative position between the first delimiting sleeve and the fastening bolt can be predetermined in a defined manner.

The holding sleeve can be held on the fastening bolt and the first delimiting sleeve, for example by frictional force. This results in particularly easy fastening without mechanical holding means being required. This refinement is suitable particularly if the holding sleeve is composed of plastic or rubber or another elastic material.

The holding sleeve can also have latching means with which said holding sleeve is held on the fastening bolt and/or on the first delimiting sleeve. This results in particularly secure holding. This refinement is also readily suitable, for example, if the holding sleeve is composed of a metal.

As already explained, the holding sleeve can be composed of plastic or metal depending on requirements. As likewise already mentioned, holding by frictional locking can easily be realized in the case of a holding sleeve composed of plastic. On the other hand, a holding sleeve composed of metal affords the advantage of particularly high temperature stability, and therefore said holding sleeve can be used without problems even in environments having high temperatures or high temperature fluctuations. Furthermore, a metal sleeve can also be held on the fastening bolt by frictional force. Said metal sleeve can be held on the first delimiting sleeve, for example by latching means.

According to a further refinement, the first delimiting sleeve can be composed of plastic or metal, and/or the second delimiting sleeve can be composed of plastic or metal. Again, the material can be selected depending on requirements. Metal as material can absorb particularly high forces and at the same time provides particularly high temperature stability. Since, in the case of the system according to the invention, the first delimiting sleeve substantially absorbs the installation force, it can be favorable to provide the first delimiting sleeve from metal. Since there are frequently no such high requirements in respect of the force absorption at the second delimiting sleeve, other materials are also suitable here, for example plastic or another elastic material. This is particularly appropriate if axial compensation for tolerances is additionally desired, as will be explained below.

Furthermore, axial compensating means can be provided which, when first and second delimiting sleeve are connected to each other, provide tolerance compensation for the axial distance between the first contact flange and the second contact flange. Said distance refers to the distance between the mutually facing inner sides of first and second contact flange, i.e. the sides of first and second contact flange that lie against the opposite sides of the first component. By tolerance compensation being provided for said distance, the system according to the invention can be used within certain limits for first components of differing thickness. Production tolerances, for example, can thereby be compensated for. The axial direction corresponds here in turn to the longitudinal axis of the fastening bolt or the installation direction thereof in the delimiting sleeves.

The axial compensating means can comprise, for example, elastic projections on the inner side, which faces the first component, of the first contact flange of the first delimiting sleeve and/or on the inner side, which faces the first component, of the second contact flange of the second delimiting sleeve. Alternatively or additionally, the axial compensating means can furthermore comprise elastic projections on that side of the first component which faces the first contact flange of the first delimiting sleeve and/or the second contact flange of the second delimiting sleeve. Said elastic projections which can be in the form, for example, of studs or the like are somewhat deformed, depending on the thickness of the first component, and therefore tolerance compensation in respect of the distance between the first and second contact flange can be provided corresponding to the deformation.

### BRIEF DESCRIPTION OF THE DRAWINGS

Exemplary embodiments of the invention will be explained in more detail below with reference to figures, in which, schematically:

FIG. 1 shows a partially sectioned view of a system according to the invention,

FIG. 2 shows a perspective view of a fastening bolt of the system shown in FIG. 1,

FIG. 3 shows a perspective view of a second delimiting sleeve of the system according to the invention shown in FIG. 1,

FIG. 4 shows a first perspective view of a first delimiting sleeve of the system according to the invention shown in FIG. 1,

FIG. 5 shows a second perspective view of the first delimiting sleeve from FIG. 4,

FIG. 6 shows a first perspective view of a first delimiting sleeve for the system, shown in FIG. 1, according to a further exemplary embodiment,

FIG. 7 shows a second perspective view of the first delimiting sleeve from FIG. 6,

FIG. 8 shows a perspective view of a holding sleeve for the system, shown in FIG. 1, according to a further exemplary embodiment,

FIG. 9 shows a first perspective view of a second delimiting sleeve for the system, shown in FIG. 1, according to a further exemplary embodiment,

FIG. 10 shows a second perspective view of the second delimiting sleeve shown in FIG. 9,

FIG. 11 shows a partially sectioned view of a system according to the invention according to a further exemplary embodiment,

FIG. 12 shows a partially sectioned view of a system according to the invention according to a further exemplary embodiment,

FIG. 13 shows a first perspective view of a fastening bolt of the system shown in FIG. 12,

FIG. 14 shows a second perspective view of the fastening bolt from FIG. 13,

FIG. 15 shows a first perspective view of a first delimiting sleeve of the system shown in FIG. 12,

FIG. 16 shows a second perspective view of the first delimiting sleeve from FIG. 15,

FIG. 17 shows a sectional view of the system shown in FIG. 1 in the state fastened to a first component,

FIG. 18 shows a sectional view of the system shown in FIG. 17 in a further state fastened to a first component with the first delimiting sleeve shown in FIGS. 6 and 7 and the second delimiting sleeve shown in FIGS. 9 and 10.

Unless indicated otherwise, the same reference signs denote identical objects in the figures.

### DETAILED DESCRIPTION

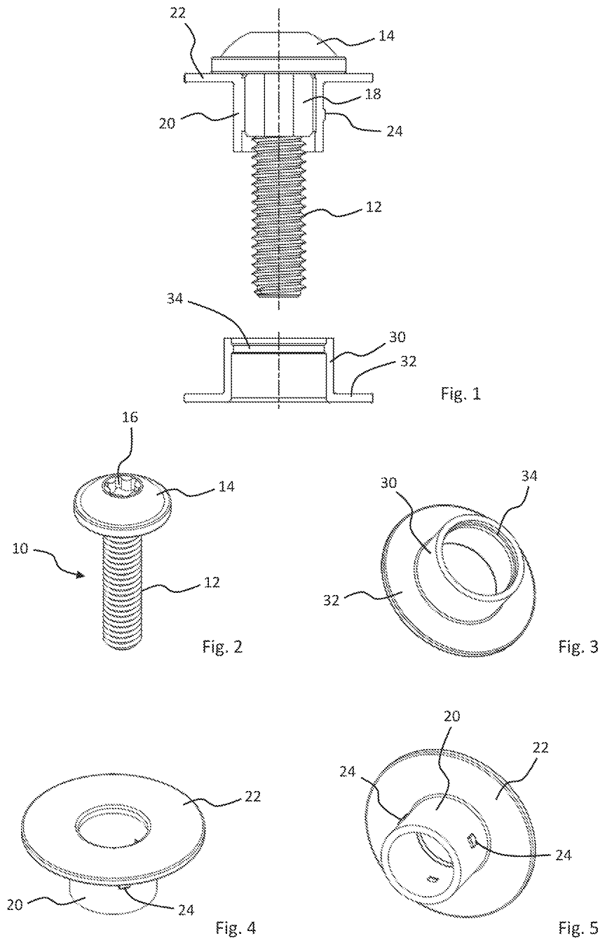

The system according to the invention shown in FIG. 1 comprises a fastening bolt 10 which is illustrated in more detail in FIG. 2; in the present case, a screw bolt, with a shank portion having an outer thread 12 and a bolt head 14 which is enlarged in cross section in relation to the shank portion and has an engagement portion 16 for a tool for rotating the fastening bolt 10. In the exemplary embodiment shown in FIG. 1, the fastening bolt 10, which can be composed, for example, of metal, is held by its shank portion 12 in a hollow cylindrical holding sleeve 18 by means of frictional locking. The holding sleeve 18, which can be composed, for example, of plastic, is, on the other hand, held in a likewise hollow cylindrical first delimiting sleeve 20 by means of frictional locking. The first delimiting sleeve 20, which can be composed, for example, of metal, has a first contact flange 22 which is in the shape of a circular ring in the example shown. In the example shown, on the outer circumferential surface of the first delimiting sleeve 20, a plurality of latching projections 24 distributed over the circumference are formed. For the installation, the fastening bolt 10 together with the first delimiting sleeve 20 is inserted into a, for example, circular cylindrical through opening 28 of a first component 26 of a vehicle, such as a passenger vehicle or truck, as is shown, for example, in FIG. 17. For said installation, the fastening bolt 10 can be inserted with its outer thread 12, for example, only partially into the holding sleeve 18, as is illustrated in FIG. 17.

For the further installation, a second delimiting sleeve 30 is subsequently inserted from the opposite side of the first component 26, i.e. from below in FIG. 17. The second delimiting sleeve 30, which, for example, can likewise be composed of metal, is likewise hollow cylindrical and likewise has a second contact flange 32 in the shape of a circular ring. In the region of that end of the second delimiting sleeve which faces away from the second contact flange 32, an annular latching projection 34 is formed on the inner circumferential surface of the second delimiting sleeve 30. In the state inserted into the through opening 28 of the first component 26, said latching projection latches on the latching projections 24 of the first delimiting sleeve 20, as can be seen in FIG. 17. As a result, first and second delimiting sleeve 20, 30 are connected releasably to each other. In said state connected to each other, the first contact flange 22 lies with its inner side, which faces the second delimiting sleeve 30, against the first component 26 from a first side, from the upper side in FIG. 17. The second contact flange 32 of the second delimiting sleeve 30 lies with its inner side, which faces the first delimiting sleeve 20, against the first component 26, on the opposite side thereof, the lower side in FIG. 17. There can be a slight clamping here such that the system is held on the first component 26.

As can readily be seen in particular in FIG. 17, there is a radial distance between the outer circumferential surface of the second delimiting sleeve 30 and the inner circumferential surface of the through opening 28. Said distance is formed by the outer diameter of the second delimiting sleeve 30 being smaller than the inner diameter of the through opening 28. In the state shown in FIG. 17, the system is displaceable in the radial direction, optionally by overcoming the clamping, specifically in each radial direction in order to ensure comprehensive radial tolerance compensation. In this manner, the fastening bolt 10 can be aligned with its shank portion 12 with respect to a fastening receptacle of a second component (not illustrated specifically in the figures) of the vehicle and inserted into the fastening receptacle, in the example illustrated screwed into an inner thread of the fastening receptacle. The first component 26 can thereby be fastened to the second component.

It can also be seen in FIG. 17 that a plurality of elastic projections 36, in particular studs 36, are formed on the side, which faces the second contact flange 32 of the second delimiting sleeve 30, the lower side in FIG. 17, of the first component 26, against which the second contact flange 32 lies. Depending on the degree of deformation of the studs 36, axial tolerance compensation with respect to the distance between the mutually facing inner sides of first and second contact flange 22, 32 can thus also be provided.

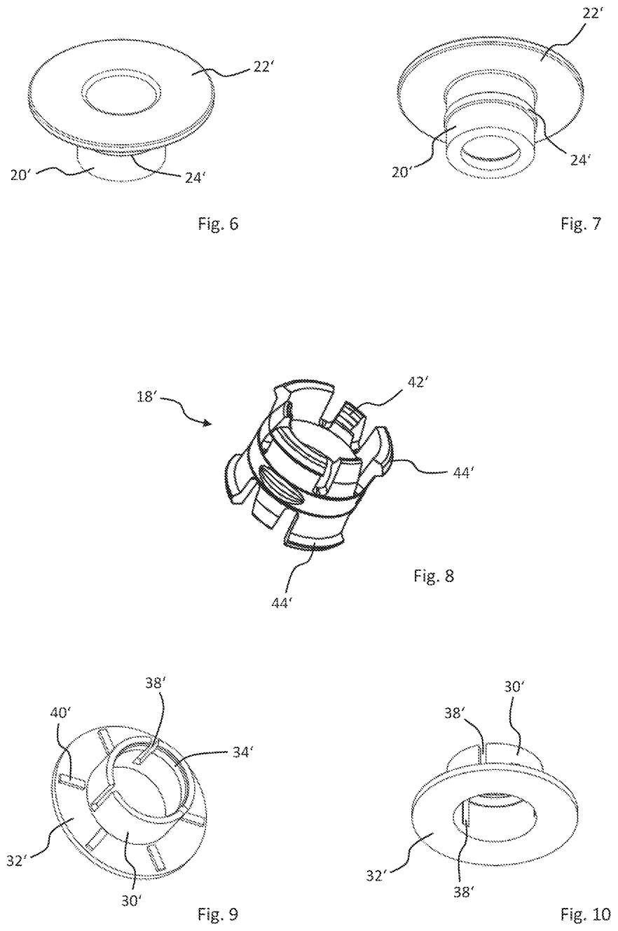

FIGS. 6 and 7 illustrate a first delimiting sleeve 20′ according to a further exemplary embodiment. In the system shown in FIG. 1, for example, said first delimiting sleeve 20′ can be used instead of the first delimiting sleeve 20. It substantially corresponds in respect of its configuration to the first delimiting sleeve 20. Accordingly, it also comprises a first contact flange 22′ in the shape of a circular ring. It differs from the first delimiting sleeve 20 shown in FIGS. 4 and 5 in respect of the latching means for latching to the second delimiting sleeve. The first delimiting sleeve 20′ according to the exemplary embodiment shown in FIGS. 6 and 7 thus has an annular latching projection 24′ on its outer circumferential surface. The first delimiting sleeve 20′ shown in FIGS. 6 and 7 can be used, for example, together with the second delimiting sleeve 30′, which is shown in FIGS. 9 and 10, according to a further exemplary embodiment in the system shown in FIG. 1. The second delimiting sleeve 30′ shown in FIGS. 9 and 10 likewise in turn has a second contact flange 32′ in the shape of a circular ring. In contrast to the second delimiting sleeve 30 shown in FIG. 3, the second delimiting sleeve 30′ according to FIGS. 9 and 10 is, however, provided with a plurality of axial slots 38′. In addition, its inner circumferential surface has an annularly encircling latching projection 34′ interrupted merely by the slots 38′. Furthermore, the inner side of the second contact flange 32, which inner side can be seen in FIG. 9 and lies against the first component 26 in the mounted state, is provided with a plurality of elastic projections 40′ distributed over the circumference. The second delimiting sleeve 30′ which is shown in FIGS. 9 and 10 can be composed, for example, of plastic. The first delimiting sleeve 20′ from FIGS. 6 and 7 can be composed, for example, from metal. However, it could also be composed of plastic in the same manner as the first delimiting sleeve 30 from FIGS. 4 and 5. The same is true of the second delimiting sleeve 30.

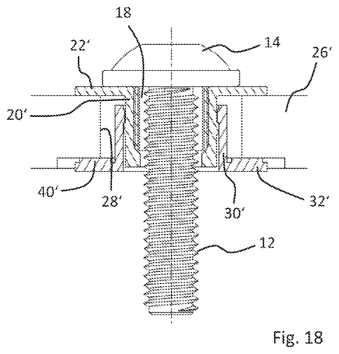

The installation with the system as shown in FIG. 1, with the first delimiting sleeve 20′ shown in FIGS. 6 and 7 and the second delimiting sleeve 30′ shown in FIGS. 9 and 10 basically takes place in the same manner as explained above with respect to the first delimiting sleeve 20 and the second delimiting sleeve 30. In this case, however, the annular latching projection 24′ of the first delimiting sleeve 20′ and the annular latching projection 34′ of the second delimiting sleeve 30′ latch to each other, with the axial slots 38′ providing sufficient elasticity of the second delimiting sleeve 30′ for said latching. The system according to the invention shown in FIG. 1 using the first delimiting sleeve 20′ and the second delimiting sleeve 30′ is shown in FIG. 18 in the state mounted on a first component 26′ with a through opening 28′. As can be seen in FIG. 18, in this case the elastic projections 40′ of the second contact flange 32′ lie against the first component 26′, the lower side of the first component 26′ in FIG. 18. Said projections, like the elastic studs 36 explained with respect to FIG. 17, also provide tolerance compensation in the axial direction.

FIG. 8 illustrates a further exemplary embodiment of a holding sleeve 18′ which, for example, can likewise be composed of plastic. Differently from the holding sleeve 18 from FIG. 1, the holding sleeve 18′ has elastic latching elements 42′ provided on its inner circumferential surface and elastic latching elements 44′ provided on its outer circumferential surface. With said elastic latching elements 42′ and 44′, the holding sleeve 18′ firstly latches on the shank portion of the fastening bolt 10 and secondly on the first delimiting sleeve 20, and therefore, in this case, the fastening bolt 10 is held in the first delimiting sleeve 20 via the holding sleeve 18′ by latching or a form fit.

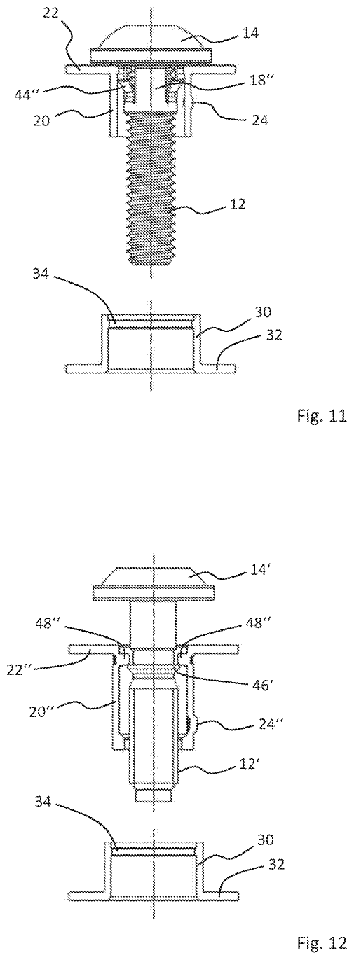

FIG. 11 illustrates a further exemplary embodiment of a system according to the invention. This very substantially corresponds to the exemplary embodiment shown in FIG. 1 and differs only in respect of the configuration of the holding sleeve. In the exemplary embodiment shown in FIG. 11, a holding sleeve 18″ is provided which likewise has elastic latching means 44″ on its outer circumferential surface and elastic latching means, which are concealed in FIG. 11, on its inner circumferential surface. With said elastic latching means, the holding sleeve 18″ from FIG. 11 latches in turn firstly on the shank portion of the fastening bolt 10 and secondly on the inner surface of the first delimiting sleeve 20. While the holding sleeve 18′ illustrated in FIG. 8 can be composed, for example, of plastic, the holding sleeve 18″ shown in FIG. 11 can be composed, for example, of metal.

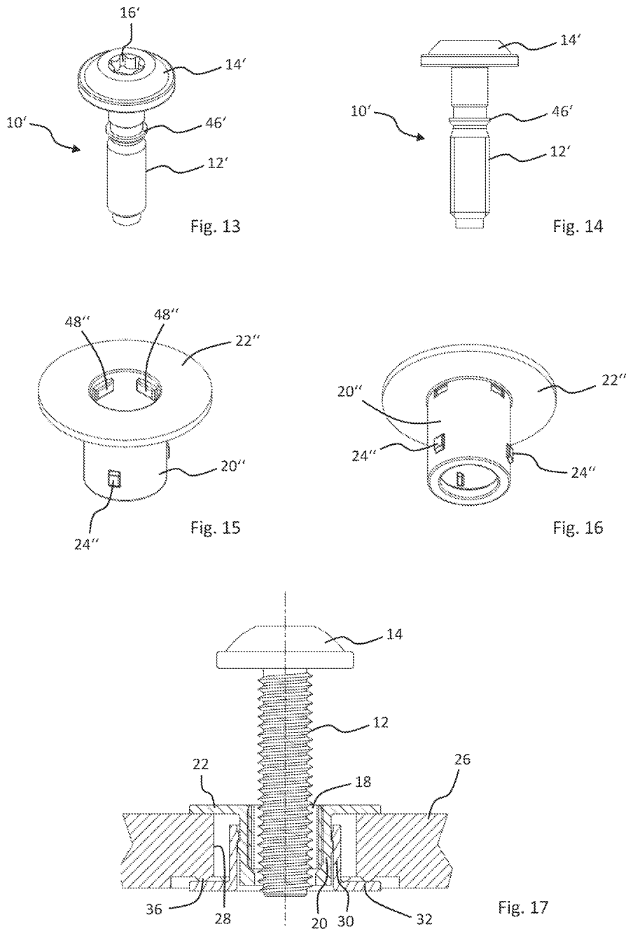

FIG. 12 illustrates a further exemplary embodiment of a system according to the invention which differs from the exemplary embodiment shown in FIG. 1 in respect of the configuration of the fastening bolt and the first delimiting sleeve. The fastening bolt 10′ used in the case of the system from FIG. 12 can be seen more precisely in FIGS. 13 and 14. It in turn has a shank portion with an outer thread 12′, not illustrated specifically in FIGS. 12 to 14, and a bolt head 14′ which is enlarged in cross section in relation to the shank portion and has an engagement portion 16′ for a rotational tool. In addition, an annularly encircling latching projection 46′ is formed between the outer thread 12′ and the bolt head 14′. With said latching projection, the fastening bolt 10′ is held in a first delimiting sleeve 20″, which is illustrated in FIGS. 15 and 16, according to a further exemplary embodiment. Said first delimiting sleeve 20″ in turn has a first contact flange 22″ in the shape of a circular ring. In addition, it has a plurality of latching projections 24″ on its outer circumferential surface. Furthermore, in the region of its end facing the first contact flange 22″, the first delimiting sleeve 20″ has a plurality of latching projections 48″ on its inner circumferential surface. Said latching projections latch on the latching projection 46′ of the fastening bolt 10′, as can be seen in particular in FIG. 12. The fastening bolt 10′ is thereby also held in a preassembly position on the first delimiting sleeve 20″ without an additional holding sleeve. The structural outlay of the system is thereby reduced further.

For the installation, the fastening bolt 10′ with the first delimiting sleeve 20″ in the preassembled state shown in FIG. 12 is inserted into the through opening 28 of the first component 30 and the second delimiting sleeve 30 is inserted into the through opening 28 from the opposite side, as has basically been explained above with respect to the system with reference to FIG. 17. The latching projections 24″ of the first delimiting sleeve 20″ latch here with the annular latching projection 24 of the second delimiting sleeve 30, and the first contact flange 22″ of the first delimiting sleeve 20″ and the second contact flange 32 of the second delimiting sleeve 30 come in turn to lie against the first component 26 from opposite sides.

The exemplary embodiments can be combined with one another here in basically any way. A common feature of all of the exemplary embodiments is that they provide comprehensive radial tolerance compensation and optionally also axial tolerance compensation while being simple to install.

### LIST OF REFERENCE SIGNS

10 Fastening bolt
10′ Fastening bolt
12 Outer thread
12′ Outer thread
14 Bolt head
14′ Bolt head
16 Engagement portion
16′ Engagement portion
18 Holding sleeve
18′ Holding sleeve
18″ Holding sleeve
20 First delimiting sleeve
20′ First delimiting sleeve
20″ First delimiting sleeve
22 First contact flange
22′ First contact flange
22″ First contact flange
24 Latching projection
24′ Latching projection
24″ Latching projection
26 First component
26′ First component
28 Through opening
28′ Through opening
30 Second delimiting sleeve
30′ Second delimiting sleeve
32 Second contact flange
32′ Second contact flange
36 Elastic projections
38′ Axial slots
40′ Elastic projections
42′ Elastic latching elements
44′ Elastic latching elements
44″ Elastic latching means
46′ Latching projection
48″ Latching projection

What is claimed is:

1. A system for fastening a first component (26, 26′) with a through opening (28, 28′) to a second component, comprising the first component (26, 26′) and a fastening bolt (10, 10′), wherein
a first delimiting sleeve (20, 20′, 20″) with a first contact flange (22, 22′, 22″) and a second delimiting sleeve (30, 30′) with a second contact flange (32, 32′) are provided, wherein the first delimiting sleeve (20, 20′, 20″) and the second delimiting sleeve (30, 30′) are insertable from opposite sides into the through opening (28, 28′) of the first component (26, 26′) and are connectable to each other by insertion of the first delimiting sleeve (20, 20′, 20″) into the second delimiting sleeve (30, 30′) such that the first contact flange (22, 22′, 22″) and the second contact flange (32, 32′) lie against the first component (26, 26′) from opposite sides, wherein the fastening bolt (10, 10′) is insertable through the delimiting sleeves (20, 20′, 20″, 30, 30′) into a fastening receptacle of the second component, and
wherein the outer diameter of the second delimiting sleeve (30, 30′) is smaller than the inner diameter of the through opening (28, 28′) of the first component (26, 26′).

2. The system as claimed in claim 1, wherein latching means are provided for latching the first delimiting sleeve (20, 20′, 20″) to the second delimiting sleeve (30, 30′).

3. The system as claimed in claim 2, wherein the latching means comprise at least one latching projection (24, 24′, 24″) and/or at least one latching receptacle on the outer circumferential surface of the first delimiting sleeve (20, 20′, 20″) and at least one latching projection (34, 34′) and/or at least one latching receptacle on the inner circumferential surface of the second delimiting sleeve (30, 30′).

4. The system as claimed in claim 1, wherein holding means are provided for holding the fastening bolt (10, 10′) in the first delimiting sleeve (20, 20′, 20″) in a preassembly position.

5. The system as claimed in claim 4, wherein the holding means comprise latching means on the inner circumferential surface of the first delimiting sleeve (20, 20′, 20″).

6. The system as claimed in claim 5, wherein the latching means comprise at least one latching projection (48″) and/or at least one latching receptacle on the inner circumferential surface of the first delimiting sleeve (20″).

7. The system as claimed in claim 6, wherein the holding means comprise latching means on the outer circumferential surface of the fastening bolt (10, 10′).

8. The system as claimed in claim 7, wherein the latching means (44″) comprise at least one latching projection (46′) and/or at least one latching receptacle on the outer circumferential surface of the fastening bolt (10′).

9. The system as claimed in claim 8, wherein the holding means comprise a holding sleeve (18, 18′, 18″) which can be pushed onto the fastening bolt (10, 10′) and can be inserted into the first delimiting sleeve (20, 20′, 20″).

10. The system as claimed in claim 9, wherein the holding sleeve (18, 18′, 18′) is held on the fastening bolt (10, 10′) and the first delimiting sleeve (20, 20′, 20″) by frictional force.

11. The system as claimed in claim 10, wherein the holding sleeve (18′, 18″) has latching means with which said holding sleeve is held on the fastening bolt (10, 10′) and/or on the first delimiting sleeve (20, 20′, 20″).

12. The system as claimed in claim 11, wherein the holding sleeve (18, 18′, 18″) is composed of plastic or metal.

13. The system as claimed in claim 1, wherein the first delimiting sleeve (20, 20′, 20″) is composed of plastic or metal, and/or wherein the second delimiting sleeve (30, 30′) is composed of plastic or metal.

14. The system as claimed in claim 1, wherein axial compensating means are provided which, when first and second delimiting sleeve (20, 20′, 20″, 30, 30′) are connected to each other, provide tolerance compensation for the axial distance between the first contact flange (22, 22′, 22″) and the second contact flange (32, 32′).

15. The system as claimed in claim 14, wherein the axial compensating means comprise elastic projections (40′) on the inner side, which faces the first component (26, 26′), of the first contact flange (22, 22′, 22″) of the first delimiting sleeve (20, 20′, 20″) and/or on the inner side, which faces the first component (26, 26′), of the second contact flange (32, 32′) of the second delimiting sleeve (30, 30′, 30″), and/or wherein the axial compensating means comprise elastic projections (36′) on that side of the first component (26, 26′) which faces the first contact flange (22, 22′, 22″) of the first delimiting sleeve (20, 20′, 20″) and/or the second contact flange (32, 32′) of the second delimiting sleeve (30, 30′).

16. A system for fastening a first component (26, 26′) with a through opening (28, 28′) to a second component, comprising:
the first component (26, 26′) having a first side and a second side, wherein the second side is opposite the first side;
a fastening bolt (10, 10′);
a first delimiting sleeve (20, 20′, 20″) with a first contact flange (22, 22′, 22″);
a second delimiting sleeve (30, 30′) with a second contact flange (32, 32′);
wherein the first delimiting sleeve (20, 20′, 20″) and the second delimiting sleeve (30, 30′) are insertable from opposite sides into the through opening (28, 28′) of the first component (26, 26′) and are connectable to each other by insertion of the first delimiting sleeve (20, 20′, 20″) into the second delimiting sleeve (30, 30′) such that the first contact flange (22, 22′, 22″) lies against the first side of the first component and the second contact flange (32, 32′) lies against the second side against the first component (26, 26′);
wherein the fastening bolt (10, 10′) is insertable through the delimiting sleeves (20, 20′, 20″, 30, 30′) into a fastening receptacle of the second component, and
wherein an outer diameter of the second delimiting sleeve (30, 30′) is smaller than an inner diameter of the through opening (28, 28′) of the first component (26, 26′).

17. The system as claimed in claim 16, wherein latching means are provided for latching the first delimiting sleeve (20, 20′, 20″) to the second delimiting sleeve (30, 30′).

18. The system as claimed in claim 17, wherein the latching means comprise at least one latching projection (24, 24′, 24″) and/or at least one latching receptacle on the outer circumferential surface of the first delimiting sleeve (20, 20′, 20″) and at least one latching projection (34, 34′) and/or at least one latching receptacle on the inner circumferential surface of the second delimiting sleeve (30, 30′).
